(19) United States
(12) Patent Application Publication
(10) Pub. No.: US 2026/0189877 A1
(43) Pub. Date: Jul. 2, 2026

(54) DETERMINATION APPARATUS, TERMINAL, SERVER, DETERMINATION METHOD, AND COMPUTER READABLE STORAGE MEDIUM

(71) Applicant: HONDA MOTOR CO.,LTD., Tokyo (JP)

(72) Inventor: Takahiro KUREHASHI, Saitama (JP)

(21) Appl. No.: 19/370,778

(22) Filed: Oct. 28, 2025

(30) Foreign Application Priority Data
Dec. 26, 2024 (JP) 2024-229864

(51) Int. Cl. H04W 4/029; H04W 4/33

(52) U.S. Cl. CPC H04W 4/029; H04W 4/33

(57) ABSTRACT

A determination apparatus includes: a first acquisition unit which acquires first information indicating positional relationships between a terminal and one or more other terminals; a second acquisition unit which acquires second information indicating at least one of a determination result, which is acquired in another terminal included in the other terminals, as to whether or not the another terminal is located indoors or positioning accuracy of the another terminal; and a determination unit which determines whether or not the terminal is located indoors, based on the first information and the second information.

The contents of the following patent application(s) are incorporated herein by reference:

NO. 2024-229864 filed in JP on December 26, 2024.

### BACKGROUND

### 1. TECHNICAL FIELD

The present invention relates to a determination apparatus, a terminal, a server, a determination method, and a computer readable storage medium.

### 2. RELATED ART

Patent Documents 1 and 2 describe a technique for determining whether a portable terminal is located indoors or outdoors.

### Related Art Documents

### Patent documents

Patent Document 1: Japanese Patent Application Publication No. 2014-123847

Patent Document 2: Japanese Patent Application Publication No. 2020-071666

### BRIEF DESCRIPTION OF THE DRAWINGS

FIG. 1 schematically illustrates a usage scene of an assistance system 10.

FIG. 2 illustrates a functional configuration of a terminal 82.

FIG. 3 illustrates a functional configuration of a server 60.

FIG. 4 illustrates a flowchart related to a determination method for determining whether or not the terminal 82 is located indoors.

FIG. 5 is a diagram for explaining a situation in which it is likely to be determined that the terminal 82 that is located indoors is not located indoors.

FIG. 6 illustrates, in a table format, importance information used to determine an importance of second information used in a determination unit 340.

FIG. 7 illustrates an example of an execution sequence of processing performed in the terminal 82, an in-vehicle information processing apparatus 40 of a vehicle 20, and the server 60.

FIG. 8 illustrates another example of the execution sequence of the processing performed in the terminal 82, the in-vehicle information processing apparatus 40 of the vehicle 20, and the server 60.

FIG. 9 illustrates another example of the execution sequence of the processing performed in the terminal 82, the in-vehicle information processing apparatus 40 of the vehicle 20, and the server 60.

FIG. 10 illustrates an example of a computer 2000 in which a plurality of embodiments of the present invention may be entirely or partially embodied.

### DESCRIPTION OF EXEMPLARY EMBODIMENTS

Hereinafter, the present invention will be described through embodiments of the invention, but the following embodiments do not limit the invention according to the claims. In addition, not all combinations of features described in the embodiments are essential to a solution of the invention.

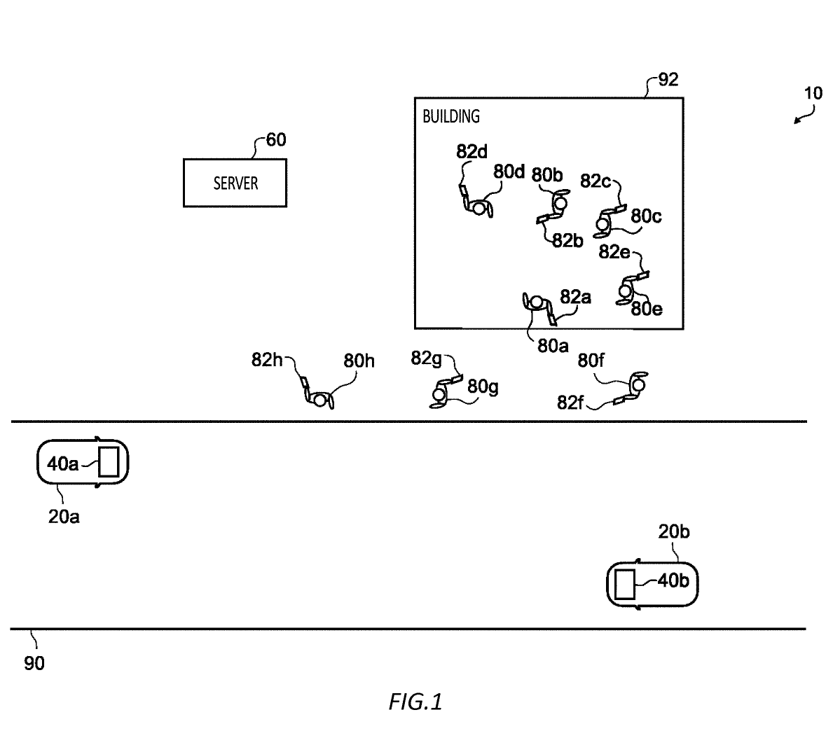

FIG. 1 schematically illustrates a usage scene of an assistance system 10. The assistance system 10 includes a vehicle 20a and a vehicle 20b, a terminal 82a, a terminal 82b, a terminal 82c, a terminal 82d, a terminal 82e, a terminal 82f, a terminal 82g, and a terminal 82h, and a server 60.

The vehicle 20a includes an in-vehicle information processing apparatus 40a, and the vehicle 20b includes an in-vehicle information processing apparatus 40b. The terminal 82a is a terminal possessed by a person 80a, the terminal 82b is a terminal possessed by a person 80b, the terminal 82c is a terminal possessed by a person 80c, the terminal 82d is a terminal possessed by a person 80d, the terminal 82e is a terminal possessed by a person 80e, the terminal 82f is a terminal possessed by a person 80f, the terminal 82g is a terminal possessed by a person 80g, and the terminal 82h is a terminal possessed by a person 80h.

In the present embodiment, the vehicle 20a and the vehicle 20b may be collectively referred to as a “vehicle 20”. The in-vehicle information processing apparatus 40a and the in-vehicle information processing apparatus 40b may be collectively referred to as the “in-vehicle information processing apparatus 40”. The terminal 82a, the terminal 82b, the terminal 82c, the terminal 82d, the terminal 82e, the terminal 82f, the terminal 82g, and the terminal 82h may be collectively referred to as a “terminal 82”. The person 80a, the person 80b, the person 80c, the person 80d, the person 80e, the person 80f, the person 80g, and the person 80h may be collectively referred to as a “person 80”. The person 80 is, for example, a pedestrian.

The vehicle 20 is a vehicle traveling on a road 90. The vehicle 20 is an example of a moving body. The vehicle 20 includes various sensors such as a position sensor including a receiver which receives a satellite signal from a global navigation satellite system (GNSS) satellite, a vehicle speed sensor, an imaging apparatus, and a radar. The in-vehicle information processing apparatus 40 has a function of processing information acquired by the various sensors included in the vehicle 20. The in-vehicle information processing apparatus 40 has a function of communicating with each of the in-vehicle information processing apparatuses 40 of another vehicle 20 and the server 60. The in-vehicle information processing apparatus 40 provides an advanced driver assistance system (ADAS) function included in the vehicle 20.

The terminal 82 is, for example, a portable terminal such as a smartphone. The terminal 82 is an example of a mobile terminal. The terminal 82 has a positioning function. The terminal 82 receives a satellite signal from a positioning satellite (for example, a GNSS satellite) such as a GNSS satellite, for example, and measures a current position of the terminal 82 based on the received satellite signal. The terminal 82 periodically transmits, to the server 60, position information indicating the measured current position of the terminal 82 as position information of the person 80.

The terminal 82 acquires positioning accuracy of the terminal 82 calculated based on a satellite signal from a positioning satellite. Examples of the positioning accuracy of the terminal 82 may include reception sensitivity of a satellite signal by the terminal 82, a number of at least one satellite from which a satellite signal is received by the terminal 82, an elevation angle of a satellite signal, or the like.

The server 60 receives information transmitted from the in-vehicle information processing apparatus 40 and the terminal 82 by mobile communication. The server 60 may receive information transmitted from the in-vehicle information processing apparatus 40 and the terminal 82 through mobile communication and a communication line such as the Internet and a dedicated line.

The server 60 provides traffic assistance to the vehicle 20, based on position information of the vehicle 20 and the person 80 received from the in-vehicle information processing apparatus 40 and the user terminal 82. For example, the server 60 determines whether or not the person 80 and the vehicle 20 approach each other within a predetermined time of period, based on the position information of the vehicle 20 and the person 80, and provides traffic assistance to the vehicle 20 and/or the person 80 when it is determined that the person 80 and the vehicle 20 approach each other within the predetermined time of period. For example, the server 60 provides traffic assistance by transmitting, as information indicating a traffic risk, alert information instructing the in-vehicle information processing apparatus 40 and the user terminal 82 to output an alert.

In the present embodiment, the terminal 82 determines whether or not the terminal 82 is located in a building. When it is determined that the terminal 82 is not located in the building, the terminal 82 transmits position information of the terminal 82. On the other hand, when it is determined that the terminal 82 is located in the building, the terminal 82 suppresses transmission of the position information of the terminal 82. For example, the terminals 82f, 82g, and 82h determined to be located outside the building 92 transmit the position information, but the terminals 82b, 82c, 82d, and 82e determined to be located in the building 92 do not transmit the position information.

FIG. 1 illustrates a case where the person 80a enters a building 92. The terminal 82a performs short-distance wireless communication with other terminals 82 around the terminal 82a, and receives information indicating the positioning accuracy of the other terminals 82.

Examples of the short-distance wireless communication may include wireless communication conforming to a BLUETOOTH (registered trademark) standard. The terminal 82a acquires distances between the other terminals 82 and the terminal 82a, based on a wireless signal used for communication with the other terminals 82.

For example, the terminal 82a acquires the distances between the other terminals 82 and the terminal 82a, based on signal strength of the wireless signal used for the short-distance wireless communication, a flight time of the wireless signal, and/or the like. For example, the terminal 82a may acquire a distance between each of the other terminals 82 and the terminal 82a, based on an RSSI of a BLUETOOTH low energy (BLE) beacon from each of the other terminals 82. The terminal 82a may acquire the distance between each of the other terminals 82 and the terminal 82a, based on a flight time of an ultra wide band (UWB) pulse signal.

The terminal 82a extracts, from the positioning accuracy received from the other terminals 82, positioning accuracy received from other terminals 82 having a distance to the terminal 82a (may be referred to as a relative distance) shorter than a predetermined value. Based on the extracted positioning accuracy, the terminal 82a determines whether or not the terminal 82a is located indoors, based on a number of at least one other terminal 82 having positioning accuracy lower than a predetermined value and a number of at least one other terminal 82 having positioning accuracy higher than or equal to the predetermined value. As an example, when the number of at least one other terminal 82 having positioning accuracy lower than the predetermined value is larger than the number of at least one other terminal 82 having positioning accuracy higher than or equal to the predetermined value, the terminal 82 determines that the terminal 82a is located indoors.

For example, among other terminals 82b, 82c, 82d, 82e, 82f, and 82g having relative distances shorter than the predetermined value, the positioning accuracy of the terminals 82b, 82c, 82d, and 82e is less than the predetermined value, and the positioning accuracy of the terminals 82f and 82g is higher than or equal to the predetermined value, so that the terminal 82a determines that the terminal 82a is located indoors. Accordingly, the terminal 82a suppresses transmission of the position information to the server 60. Accordingly, it is possible to suppress the server 60 from wastefully providing traffic assistance to the terminal 82a.

For example, among other terminals 82a, 82f, and 82h having relative distances shorter than the predetermined value, the positioning accuracy of the terminal 82a is lower than the predetermined value, and the positioning accuracy of the terminals 82f and 82h is higher than or equal to the predetermined value, so that the terminal 82g determines that the terminal 82g is not located indoors. Specifically, the terminal 82g determines that the terminal 82g is located outdoors. Accordingly, the terminal 82g transmits the position information to the server 60. Accordingly, the server 60 can provide traffic assistance based on the position information of the terminal 82g.

As a method of determining whether or not the terminal 82 is located indoors, there is a method of determining whether or not the terminal 82 is located indoors, based on a level of reception intensity of a satellite signal from a positioning satellite. In this method, for example, when the terminal 82 can receive a satellite signal having a relatively high intensity as compared with a case where the terminal 82 is located at a back of the building 92, such as a case where the terminal 82 is located near an entrance of the building 92 or located near a window of the building 92, it may not be possible to accurately determine whether or not the terminal 82 is located indoors, based on the level of reception intensity of the satellite signal. On the other hand, according to the present embodiment, when many other terminals 82 with low positioning accuracy are present around the terminal 82a, the terminal 82a located near the entrance of the building 92 determines that the terminal 82a is located indoors. Accordingly, it may be possible to accurately determine whether or not the terminal 82a is located indoors, as compared with a case where determination is made based on the level of reception intensity of the satellite signal.

According to the present embodiment, it is possible to suppress the terminal 82a in the building 92, for which the necessity of providing traffic assistance is low, from transmitting the position information of the terminal 82a to the server 60. Accordingly, in the terminal 82a, power consumption for the terminal 82a to transmit the position information can be reduced. Further, an amount of computation required for processing performed by the server 60 for traffic assistance can be reduced. On the other hand, since the terminal 82g located outside the building 92 transmits the position information to the server 60, the server 60 can provide traffic assistance based on the position information of the terminal 82g. Accordingly, traffic safety can be ensured.

In the present embodiment, similarly to the terminal 82, the server 60 has a function of determining whether or not the terminal 82 is located indoors. For example, the server 60 receives, from each of the terminals 82, information indicating relative distances between each of the terminals 82 and other terminals 82 and information indicating positioning accuracy of each of the terminals 82. The server 60 determines whether or not each of the terminals 82 is located indoors, based on the information received from each of the terminals 82 by the method described in relation to the terminal 82a, the terminal 82g, and the like. The server 60 provides traffic assistance in consideration of a determination result as to whether or not the terminal 82 is located indoors. Since the server 60 has the function of determining whether or not the terminal 82 is located indoors, even when there is a terminal 82 that does not have the function of determining whether or not the terminal itself is located indoors, the server 60 can provide traffic assistance in consideration of the determination result as to whether or not the terminal 82 is located indoors.

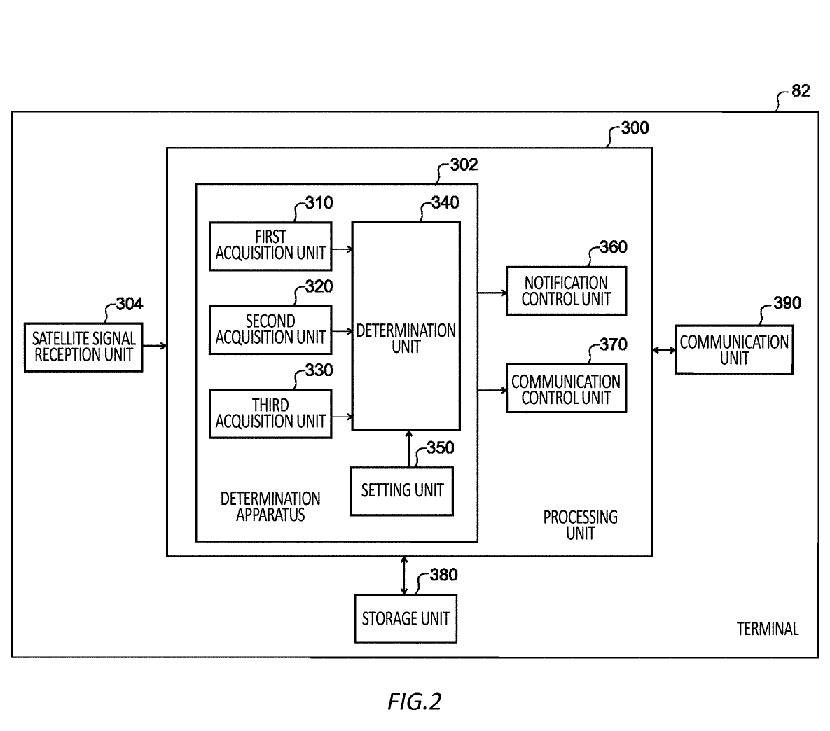

FIG. 2 illustrates a functional configuration of the terminal 82. The terminal 82 includes a processing unit 300, a satellite signal reception unit 304, a communication unit 390, and a storage unit 380.

The communication unit 390, under the control of the processing unit 300, is responsible for communication with the server 60. The processing unit 300 is realized by providing, for example, a circuit such as an arithmetic processing apparatus including a processor. The processing unit 300 may be realized by a microcomputer including a CPU, a ROM, a RAM, an I/O, a bus, and the like. The storage unit 380 is realized by providing a nonvolatile storage medium. The processing unit 300 performs processing by using information stored in the storage unit 380.

The processing unit 300 includes a determination apparatus 302, a notification control unit 360, and a communication control unit 370. The determination apparatus 302 includes a first acquisition unit 310, a second acquisition unit 320, a third acquisition unit 330, a determination unit 340, and a setting unit 350. A configuration in which the terminal 82 does not have a partial function of the functional configuration illustrated in FIG. 2 may be adopted.

The satellite signal reception unit 304 receives a satellite signal transmitted from a positioning satellite such as a GNSS satellite, and outputs a position of the terminal 82 based on the received signal. The satellite signal reception unit 304 further outputs information indicating positioning accuracy based on the satellite signal.

The positioning accuracy includes at least one of reception sensitivity of a satellite signal, a number of at least one satellite used for positioning, or an elevation angle of the satellite signal. The reception sensitivity may be received signal strength. The reception sensitivity may be, for example, information indicating signal strength of a satellite signal received by the terminal 82. The reception sensitivity may be a signal-to-noise ratio, a carrier noise power density ratio, or the like. The number of at least one satellite used for positioning may be a number of at least one satellite that can be used for positioning or a number of at least one satellite that has been used for positioning. The elevation angle of the satellite signal may be an average value of elevation angles of received satellite signals, or may be an average value of elevation angles of satellite signals each having an elevation angle larger than a predetermined value. The positioning accuracy may be an accuracy value. The positioning accuracy may be various DOP values or the like. The satellite signal reception unit 304 may output other various types of information indicating the positioning accuracy.

The first acquisition unit 310 acquires first information indicating positional relationships between the terminal 82 and one or more other terminals 82. For example, the first information may include information indicating distances between the terminal 82 and other terminals 82.

The second acquisition unit 320 acquires second information indicating at least one of a determination result, which is acquired in another terminal 82, as to whether or not the another terminal 82 is located indoors or the positioning accuracy of the another terminal 82. The positioning accuracy of the another terminal 82 may be at least one of reception sensitivity of a satellite signal received by the another terminal 82 from a positioning satellite, a number of at least one satellite used for positioning for the another terminal 82, or an elevation angle of the satellite signal. The information indicating the positioning accuracy of the another terminal 82 may be information, which is determined by the another terminal 82, indicating whether or not the positioning accuracy is higher than the predetermined value.

The determination unit 340 determines whether or not the terminal 82 is located indoors, based on the first information and the second information. For example, the determination unit 340 selects another terminal 82 having a distance to the terminal 82 shorter than the predetermined value, based on the first information, and determines whether or not the terminal 82 is located indoors, based on the second information of the selected another terminal 82. In this manner, even when it is not easy to determine whether or not the terminal 82 is located indoors, for example, when the terminal 82 is near the entrance of the building 92, by determining whether or not the terminal 82 is located indoors in consideration of a positional relationship with another surrounding terminals 82, and positioning accuracy of the another surrounding terminal 82, and/or a determination result as to whether or not the another terminal 82 is located indoors, whether or not the terminal 82 is located indoors can be determined with higher accuracy.

The third acquisition unit 330 acquires third information indicating a moving state of another terminal 82. The third information may indicate a moving amount of the another terminal 82 per unit time. When the another terminal 82 is a portable terminal, the third information may indicate a step count counted in the another terminal 82. The third information may indicate a step count counted by a step counter included in the another terminal 82. For example, the third information may indicate a step count counted based on an acceleration detected by an acceleration sensor included in the another terminal 82. The third acquisition unit may acquire the third information based on a change amount of a distance between the terminal 82 and the another terminal 82 acquired by the short-distance wireless communication.

The determination unit 340 may determine whether or not the terminal 82 is located indoors, based on the first information, the second information, and the third information. The determination unit 340 may calculate an importance of the second information based on the third information, and determine whether or not the terminal 82 is located indoors, by using the calculated importance. The determination unit 340 may calculate the importance of the second information based on the second information and the third information, and determine whether or not the terminal 82 is located indoors, by using the calculated importance.

The determination unit 340 may determine whether or not the terminal 82 is located indoors by calculating an index value for determining whether or not the terminal 82 is located indoors, based on the first information and the second information and comparing the index value with a threshold. The setting unit 350 may set the threshold based on an instruction from a user of the terminal 82.

The communication control unit 370 controls content of communication between the terminal 82 and an external server, based on a determination result of the determination unit 340. For example, the communication unit 390 transmits position information of the terminal 82 to the server 60, which distributes information indicating a traffic risk at a position where the terminal 82 is present, and the communication control unit 370 restricts the transmission of the position information to the server by the communication unit 390, based on the determination result of the determination unit 340.

The communication unit 390 receives information indicating a traffic risk at a position where the terminal 82 is present, from the server 60, which distributes the information indicating the traffic risk. The notification control unit 360 performs control for performing notification based on the information, which is received by the communication unit 390, indicating the traffic risk. The notification control unit 360 restricts the notification when the determination unit 340 determines that the terminal 82 is located indoors. Accordingly, when it is determined that the terminal 82 is located indoors, it is possible to suppress notification of the information regarding the traffic risk.

The communication unit 390 may transmit, to the server 60, information indicating positional relationships between the terminal 82 and one or more other terminals 82, and information indicating at least one of a determination result as to whether or not the terminal 82 is located indoors or positioning accuracy of the terminal 82. The communication unit 390 may further transmit, to the server 60, information indicating a moving state of the terminal 82. Accordingly, the server 60 can appropriately determine whether or not the terminal 82 is located indoors. The communication unit 390 may transmit the determination result of the determination unit 340 to the server 60, which distributes the information indicating the traffic risk at the position where the terminal 82 is present.

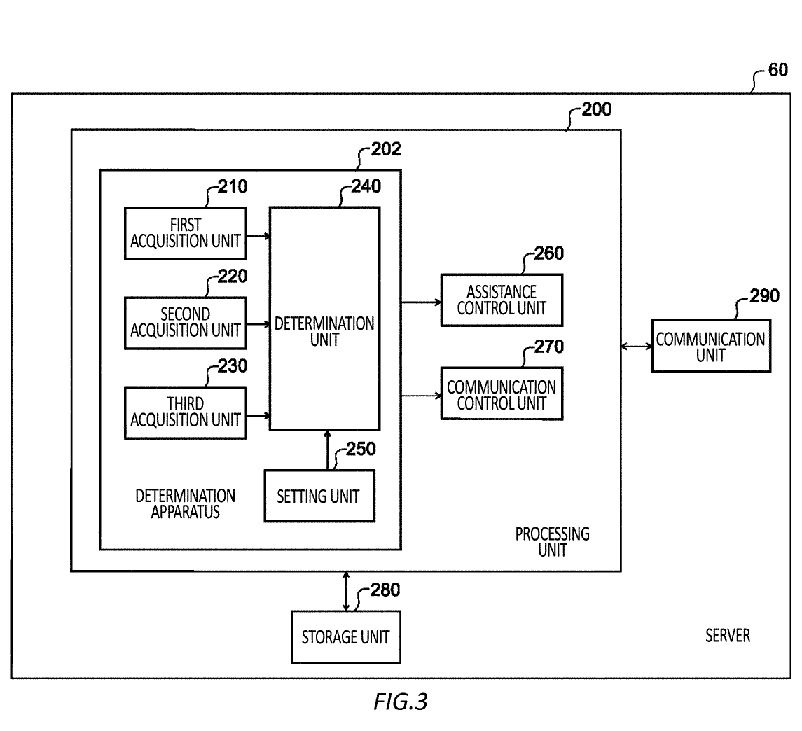

FIG. 3 illustrates a functional configuration of the server 60. The server 60 includes a processing unit 200, a communication unit 290, and a storage unit 280.

The communication unit 290, under control of the processing unit 200, performs communication between the in-vehicle information processing apparatus 40, each of the terminals 82, and the server 60. The processing unit 200 is realized by providing, for example, a circuit such as an arithmetic processing apparatus including a processor. The processing unit 200 may be realized by a microcomputer including a CPU, a ROM, a RAM, an I/O, a bus, and the like. The storage unit 280 is realized by providing a nonvolatile storage medium. The processing unit 200 performs processing by using information stored in the storage unit 280.

The communication unit 290 receives position information transmitted from the terminal 82. The communication unit 290 receives information, which is transmitted from the terminal 82, indicating positional relationships between the terminal 82 and one or more other terminals 82. The communication unit 290 receives information indicating at least one of a determination result as to whether or not the terminal 82 is located indoors or the positioning accuracy of the terminal 82. The communication unit 290 receives information, which is transmitted from the terminal 82, indicating a moving state of the terminal 82.

The processing unit 200 includes a determination apparatus 202, an assistance control unit 260, and a communication control unit 270. The determination apparatus 202 includes a first acquisition unit 210, a second acquisition unit 220, a third acquisition unit 230, a determination unit 240, and a setting unit 250. A configuration in which the server 60 does not have a partial function of the functional configuration illustrated in FIG. 3 may be adopted.

The first acquisition unit 210 acquires first information indicating positional relationships between the terminal 82 and one or more other terminals 82. For example, the first information may include information indicating distances between the terminal 82 and other terminals 82.

The second acquisition unit 220 acquires second information indicating at least one of a determination result, which is acquired in the terminal 82, as to whether or not the terminal 82 is located indoors or the positioning accuracy of the terminal 82. The positioning accuracy of the terminal 82 may be at least one of reception sensitivity of a satellite signal received by the terminal 82 from a positioning satellite, a number of at least one satellite used for positioning for the terminal 82, or an elevation angle of the satellite signal.

The determination unit 240 determines whether or not the terminal 82 is located indoors, based on the first information and the second information. For example, the determination unit 240 selects another terminal 82 having a distance to the terminal 82 shorter than the predetermined value, based on the first information, and determines whether or not the terminal 82 is located indoors, based on the second information of the selected another terminal 82.

The third acquisition unit 230 acquires third information indicating a moving state of the terminal 82. The third information may indicate a moving amount of the terminal 82 per unit time. When the terminal 82 is a portable terminal, the third information may indicate a step count counted in the terminal 82. The third information may indicate a step count counted by a step counter included in the terminal 82. For example, the third information may indicate a step count counted based on an acceleration detected by an acceleration sensor included in the terminal 82. The third acquisition unit may acquire the third information calculated based on a change amount of a distance between the terminal 82 and another terminal 82 acquired by the terminal 82 through the short-distance wireless communication.

The determination unit 240 may determine whether or not the terminal 82 is located indoors, based on the first information, the second information, and the third information. The determination unit 240 may calculate an importance of the second information based on the second information and the third information, and determine whether or not the terminal 82 is located indoors, by using the importance.

The determination unit 240 may determine whether or not the terminal 82 is located indoors, by calculating an index value for determining whether or not the terminal 82 is located indoors, based on the first information and the second information and comparing the index value with a threshold. The setting unit 250 may set the threshold based on an instruction from the user of the terminal 82.

The communication control unit 270 performs control for transmitting information indicating a traffic risk at a position where the terminal 82 is present. When the determination unit 340 determines that the terminal 82 is located indoors, the communication control unit 270 restricts transmission of the information indicating the traffic risk at the position where the terminal 82 is present, as compared with a case where the determination unit 340 determines that the terminal 82 is not located indoors. Specifically, when it is determined that the terminal 82 is located indoors, the communication control unit 270 does not transmit the information indicating the traffic risk at the position where the terminal 82 is present, and when it is determined that the terminal 82 is not located indoors, the communication control unit 270 transmits the information indicating the traffic risk at the position where the terminal 82 is present. In this manner, the communication control unit 270 controls content of communication between the server and the terminal 82, based on the determination result of the determination unit 340.

The assistance control unit 260 performs control related to assistance for a traffic participant. The assistance control unit 260 distributes information regarding a traffic risk to the terminal 82 and the in-vehicle information processing apparatus 40. For example, the assistance control unit 260 predicts future positions of the vehicle 20 and the terminal 82, based on the position information of the vehicle 20 and the position information of the terminal 82, and predicts whether or not the vehicle 20 and the terminal 82 approach each other within a predetermined distance within a predetermined time of period. When it is predicted that the vehicle 20 and the terminal 82 approach each other within the predetermined distance within the predetermined time of period, the assistance control unit 260 transmits alert information instructing to output an alert to the terminal 82 and the vehicle 20.

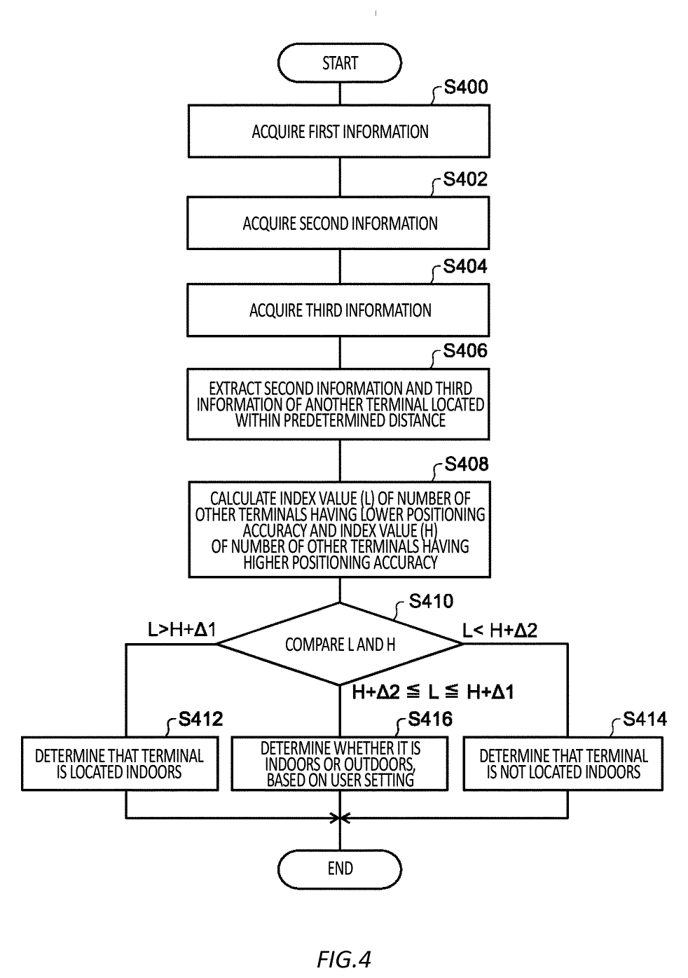

FIG. 4 illustrates a flowchart related to a determination method for determining whether or not the terminal 82 is located indoors. In FIG. 4, a determination method in which the terminal 82 itself determines whether or not the terminal 82 is located indoors will be described. Processing of this flowchart is periodically executed in the terminal 82.

In S400, the first acquisition unit 310 acquires first information indicating positional relationships between the terminal 82 and one or more other terminals 82. For example, the first information is information indicating distances between the terminal 82 and other terminals 82. The first acquisition unit 310 may calculate a distance between the terminal 82 and each of the other terminals 82, based on reception intensity of a BLE beacon transmitted from each of the other terminals 82. The first acquisition unit 310 may calculate the distance between the terminal 82 and each of the other terminals 82, based on a flight time of a pulse signal of UWB communication transmitted from each of the other terminals 82.

In S402, the second acquisition unit 320 acquires second information indicating at least one of a determination result, which is acquired in another terminal 82, as to whether or not the another terminal 82 is located indoors or the positioning accuracy of the another terminal 82. In the present embodiment, the second acquisition unit 320 acquires the second information indicating the positioning accuracy of the another terminal 82.

In S404, the third acquisition unit 330 acquires third information indicating a moving state of the another terminal 82. In the present embodiment, the third acquisition unit 330 acquires, as the third information, information indicating a step count per unit time counted in the another terminal 82. The step count per unit time is an example of a moving amount of the terminal 82 per unit time.

In S406, the determination unit 340 extracts the second information and the third information of the another terminal 82 located within a predetermined distance. For example, the determination unit 340 selects another terminal 82 having a distance to the terminal 82 shorter than a predetermined value, based on the first information, and extracts the second information and the third information of the selected terminal 82.

In step S408, the determination unit 340 calculates an index value (here, referred to as "L") of a number of at least one terminal having positioning accuracy lower than a predetermined value and an index value (here, referred to as "H") of a number of at least one terminal having positioning accuracy higher than or equal to the predetermined value. Subsequently, in S410, the determination unit 340 compares L and H calculated in S408, and determines whether or not the terminal 82 is located indoors, based on a comparison result (S412, S414, or the like). In this manner, the determination unit 340 selects another terminal 82 having a distance to the terminal 82 shorter than the predetermined value, based on the first information, and determines whether or not the terminal 82 is located indoors, based on the second information of the selected another terminal 82.

Describing the index values L and H, the index value L may be a number of at least one terminal 82 having positioning accuracy lower than the predetermined value, and the index value H may be a number of at least one terminal 82 having positioning accuracy higher than or equal to the predetermined value. The index value L may be a weighted sum of the number of at least one terminal 82 having positioning accuracy lower than the predetermined value, and the index value H may be a weighted sum of the number of at least one terminal 82 having positioning accuracy higher than or equal to the predetermined value. The index value L may be a weighted sum obtained by adding the terminals 82 having positioning accuracy lower than the predetermined value, weighted by an importance of the second information of each terminal 82, and the index value H may be a weighted sum obtained by adding the terminals 82 having positioning accuracy higher than or equal to the predetermined value, weighted by an importance of the second information of each terminal 82.

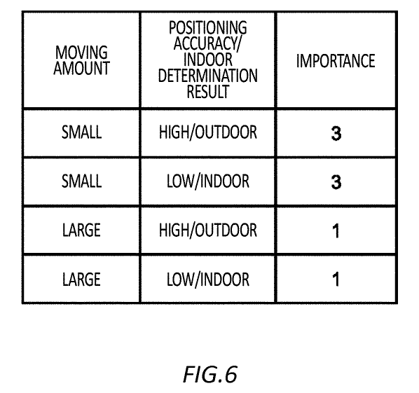

The determination unit 340 may determine the importance based on a moving state of another terminal 82. The determination unit 340 may determine the importance based on the moving state and positioning accuracy of the another terminal 82. An example of determining the importance based on the moving state and the positioning accuracy of the another terminal 82 will be described with reference to FIG. 6. The determination unit 340 may determine the importance based on a distance between the terminal 82 and the another terminal 82. The determination unit 340 may determine a higher importance as the distance between the terminal 82 and the another terminal 82 decreases. The determination unit 340 may determine the importance based on an arbitrary combination of the first information, the second information, and the third information.

In S410, the determination unit 340 compares L and H calculated in S408. For example, the determination unit 340 assumes that thresholds for determining whether or not the terminal 82 is located indoors are Δ1 and Δ2, and the determination unit 340 determines whether or not L > H + Δ1 (that is, L - H > Δ1) and whether or not L < H + Δ2 (that is, L - H < Δ2). However, a value of Δ1 is larger than or equal to a value of Δ2. Δ1 may be a positive value, and Δ2 may be a negative value. Δ1 and Δ2 may be 0.

If L > H + Δ1 is determined in S410, in S412, the determination unit 340 determines that the terminal 82 is located indoors. If L < H + Δ2 is determined in S410, in S414, the determination unit 340 determines that the terminal 82 is not located indoors. That is, the determination unit 340 determines that the terminal 82 is located outdoors. The smaller Δ1 is, the more likely the terminal 82 is determined to be located indoors. The larger Δ2 is, the more likely the terminal 82 is determined not to be located indoors.

L - H is an example of an index value for determining whether or not the terminal 82 is located indoors. As described in relation to S410, the determination unit 340 may calculate the index value (for example, L-H) for determining whether or not the terminal 82 is located indoors, based on the first information, the second information, and the third information, and determine whether or not the terminal 82 is located indoors, by comparing the index value with the threshold (Δ1 and/or Δ2).

Δ1 and Δ2 may be thresholds set by the setting unit 350 based on an instruction of the user. In this case, the setting unit 350 may set Δ1 and Δ2 based on an instruction from the person 80. For example, the setting unit 350 may allow the person 80 to select whether or not to make it more likely that the terminal 82 is determined to be located indoors, and when an instruction to make it more likely that the terminal 82 is determined to be located indoors is made by the person 80, may set Δ1 to a value smaller than a reference value (for example, 0) by a predetermined value. The setting unit 350 may allow the person 80 to select whether or not to make it more likely that the terminal 82 is determined to be located outdoors, and when an instruction to make it more likely that the terminal 82 is determined to be located outdoors is made by the person 80, may set Δ2 to a value larger than the reference value (for example, 0) by a predetermined value.

If it is determined in S410 that H + Δ2 ≤ L ≤ H + Δ1, in S416, the determination unit 340 determines whether it is indoors or outdoors, based on a user setting. The setting unit 350 may present, to the person 80, (i) determination based on a satellite signal, (ii) determination that the terminal 82 is located indoors, and (iii) determination that the terminal 82 is located outdoors, as user setting options when it cannot be determined based on L and H whether or not the terminal 82 is located indoors, and determine the user setting based on an option selected by the person 80.

If (i) is selected by the person 80 that determination is made based on a position measured based on the satellite signal and map information, in S416, the determination unit 340 (a) may determine whether or not the terminal 82 is located indoors, based on a current position of the terminal 82 detected by the satellite signal reception unit 304 and position information of the building included in map information stored in the storage unit 280, or (b) may determine that the terminal 82 is located indoors when reception intensity of a satellite signal received by the satellite signal reception unit 304 is lower than a predetermined value, and determine that the terminal 82 is not located indoors when the reception intensity of the satellite signal is higher than or equal to the predetermined value.

When (ii) is selected by the person 80 that it is determined that the terminal 82 is located indoors, in S416, the determination unit 340 may determine that the terminal 82 is located indoors. When (iii) is selected by the person 80 that it is determined that the terminal 82 is located outdoors, in S416, the determination unit 340 may determine that the terminal 82 is not located indoors.

As described with reference to FIG. 4 or the like, the determination unit 340 determines whether or not the terminal 82 is located indoors, based on the first information, the second information, and the third information. In another embodiment, the determination unit 340 may determine whether or not the terminal 82 is located indoors, based on the first information and the second information, without considering the third information. In this embodiment, the processing of S404 can be omitted. In this case, in S406, the determination unit 340 may extract the second information of the another terminal 82 located within the predetermined distance, and in S408, calculate L and H based on the extracted second information.

In FIG. 4, a case where the second information indicates the positioning accuracy has been described, but the second information may be information indicating a determination result, which is acquired in another terminal 82, as to whether or not the another terminal 82 is located indoors. Specifically, the second information may be information indicating a determination result by the determination unit 340 of the another terminal 82. In this case, in S408, the determination unit 340 may set, as L, an index value of a number of at least one other terminal 82 determined not to be located indoors, and may set, as H, an index value of a number of at least one other terminal 82 determined to be located indoors. As described above, the second information may be information indicating the determination result, which is acquired in another terminal 82, as to whether or not the another terminal 82 is located indoors and/or the positioning accuracy of the another terminal 82.

In FIG. 4, an example has been described in which, in S406, the determination unit 340 extracts the second information and the third information of another terminal 82 located within the predetermined distance from the terminal 82, and, in S408, calculates the index values L and H based on the second information and the third information extracted in S406. As another example, in S406, the determination unit 340 may additionally extract the second information and the third information of the terminal 82 as a determination target of whether or not the terminal is located indoors. Further, in S408, the determination unit 340 may determine, as an importance of the second information of the terminal 82 itself, an importance higher than that of other terminals 82. In S408, when a number of at least one other terminal 82 located within a predetermined distance from the terminal 82 is smaller than a predetermined number, the determination unit 340 may determine, as the importance of the second information of the terminal 82 itself, an importance higher than that of other terminals 82. Accordingly, by calculating the index values L and H in consideration of the second information and the third information of the terminal 82 itself, for which it is determined whether or not the terminal 82 is located indoors, it is possible to reflect information on positioning accuracy of the terminal itself in the determination result as to whether or not the terminal 82 is located indoors. Accordingly, it may be possible to improve accuracy of the determination result.

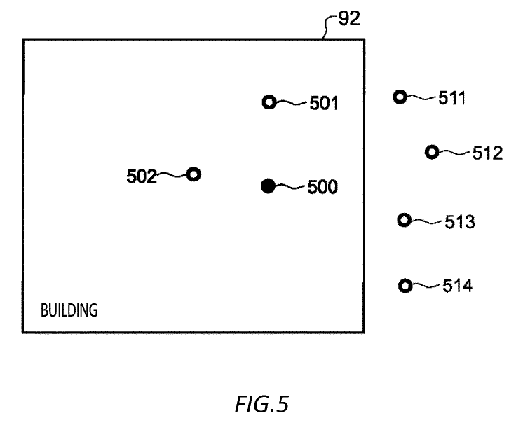

FIG. 5 is a diagram for explaining a situation in which it is likely to be determined that the terminal 82 that is located indoors is not located indoors. A reference numeral 500 indicates a position of the terminal 82 for which it is determined whether or not the terminal is located indoors.

Reference numerals 501 and 502 indicate positions of other terminals 82 located in the building 92. In the other terminals 82 corresponding to the reference numerals 501 and 502, it is assumed that positioning accuracy based on a satellite signal is lower than a predetermined value and it is determined that the terminal 82 is located in the building 92. Reference numerals 511, 512, 513, and 514 indicate positions of other terminals 82 located outside the building 92. In the other terminals 82 corresponding to the reference numerals 511, 512, 513, and 514, it is assumed that positioning accuracy based on a satellite signal is higher than or equal to the predetermined value, and it is determined that the terminal 82 is not located in the building 92.

In the situation illustrated in FIG. 5, a number of at least one other terminal 82 having positioning accuracy lower than a predetermined value is two, and a number of at least one other terminal 82 having positioning accuracy higher than or equal to the predetermined value is four. If, as a determination method in the determination unit 340, a method is adopted in which, when the number of at least one other terminal 82 having positioning accuracy is higher than or equal to the predetermined value is larger than the number of at least one other terminal 82 having positioning accuracy lower less than the predetermined value, it is determined that the terminal 82 is not located indoors (located outdoors), it is determined that the terminal 82 corresponding to the reference numeral 500 is not located indoors.

In this case, the terminal 82 corresponding to the reference numeral 500 transmits position information to the server 60, and the server 60 performs processing for traffic assistance in consideration of the position information of the terminal 82 located in the building 92. In this case, in the terminal 82, a power consumption amount for transmitting the position information may increase, and in the server 60, an amount of computation required for processing for traffic assistance may increase.

FIG. 6 illustrates, in a table format, importance information used to determine the importance of the second information used by the determination unit 340. The importance information is information that associates a moving amount, positioning accuracy/indoor determination result, and an importance.

The "moving amount" indicates a magnitude of a moving amount of another terminal 82. In FIG. 6, a moving amount “small” indicates that a moving amount of the terminal 82 per unit time is small, and a moving amount“ large” indicates that a moving amount of the terminal 82 per unit time is large. The "moving amount" may be determined based on a step count per unit time acquired in another terminal 82. For example, the determination unit 340 may set the moving amount to "small" when the step count per unit time acquired in the another terminal 82 indicated by the third information is smaller than a predetermined value, and may set the moving amount to "large" when the step count per unit time acquired in the another terminal 82 indicated by the third information is larger than or equal to the predetermined value. In addition to the step count, the “moving amount” may be a value calculated based on a history of positions transmitted from the another terminal 82, or may be a value calculated based on a temporal change amount of a distance between the terminal 82 and the another terminal 82 detected by short-distance wireless communication (for example, BLE, UWB).

The "positioning accuracy/indoor determination result" indicates a level of positioning accuracy of another terminal 82 and a determination result as to whether or not the another terminal 82 is located indoors. In FIG. 6, positioning accuracy "high" indicates that positioning accuracy of another terminal 82 is higher than or equal to a predetermined value, and positioning accuracy "low" indicates that the positioning accuracy of the another terminal 82 is lower than the predetermined value. An indoor determination result “indoor” indicates that it is determined that another terminal 82 is located indoors, and an indoor determination result “outdoor” indicates that it is determined that the another terminal 82 is not located indoors.

The "importance" indicates an importance of the positioning accuracy/indoor determination result for the determination executed by the determination unit 340. The importance is a weighting factor used when the index value L and the index value H are calculated. As illustrated in FIG. 6, an importance of another terminal 82 having a small moving amount is 3, and an importance of positioning accuracy/indoor determination result for another terminal 82 having a large moving amount is 1. As described above, the smaller the moving amount, the larger the importance is set.

In general, it can be said that the smaller the moving amount of the terminal 82, the more reliable the positioning accuracy and/or the indoor determination result for the terminal 82 can be as the positioning accuracy and/or the indoor determination result for a current position of the terminal 82. Therefore, by increasing the importance as the moving amount of the terminal 82 decreases, a reliability of the index values L and H calculated by the determination unit 340 can be enhanced.

For example, in the situation illustrated in FIG. 5, the terminals 82 corresponding to the reference numerals 501 and 502 are terminals possessed by the persons 80 in the building 92, and the terminals 82 corresponding to the reference numerals 511 to 514 are terminals possessed by the persons 80 walking. In general, a person outside a building often moves faster than a person inside a building, so that the moving amount of the terminal 82 increases. Accordingly, when the importance of the positioning accuracy and/or the indoor determination result for the terminals 82 corresponding to the reference numerals 501 and 502 are 3, and the importance of the positioning accuracy and/or the indoor determination result for the terminals 82 corresponding to the reference numerals 511 to 514 are 1, the index value L is calculated to be 6, and the index value H is calculated to be 4. Accordingly, in the terminal 82 corresponding to the reference numeral 500, the determination unit 340 determines that the terminal 82 is located indoors.

As described with reference to FIGS. 4 to 6 or the like, the determination unit 340 determines whether or not the terminal 82 is located indoors, in consideration of a moving amount of another terminal 82, whereby a reliability of a determination result can be enhanced. In the example of FIG. 6, a case where the importance of the second information is calculated based on the second information and the third information has been exemplified, but the importance of the second information may be calculated based on the third information.

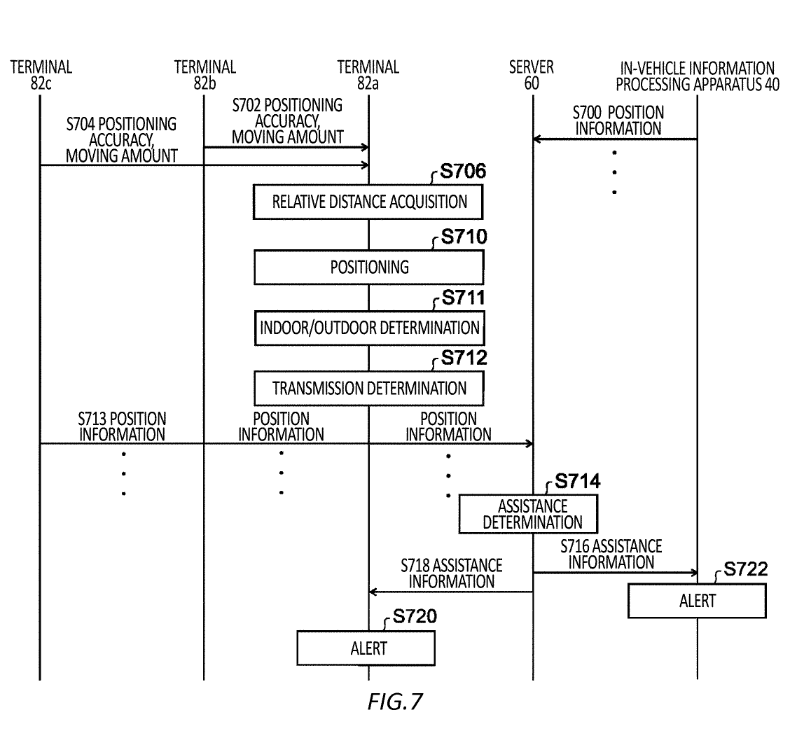

FIG. 7 illustrates an example of an execution sequence of processing performed in the terminal 82, the in-vehicle information processing apparatus 40 of the vehicle 20, and the server 60. FIG. 7 particularly illustrates an execution sequence when the information terminal 82a itself determines whether or not the terminal 82a is located indoors, based on positioning accuracy information from the terminal 82b and the terminal 82c, and the terminal 82a itself determines whether or not to transmit position information. In the execution sequence of FIG. 7, it is assumed that the terminal 82b and the terminal 82c are determined to be located outdoors.

In S700, the in-vehicle information processing apparatus 40 transmits position information of the vehicle 20 to the server 60. The position information is periodically transmitted from the in-vehicle information processing apparatus 40 to the server 60.

In S702, the terminal 82b transmits, to the terminal 82a, information indicating positioning accuracy and a moving amount for the terminal 82b. In S704, the terminal 82c transmits, to the terminal 82a, information indicating positioning accuracy and a moving amount for the terminal 82c. The transmission of the information indicating the positioning accuracy and the moving amount from the terminal 82b and the terminal 82c may be performed periodically. The transmission of the information indicating the positioning accuracy and the moving amount from the terminal 82b and the terminal 82c may be performed by a broadcast method. The transmission of the information indicating the positioning accuracy and the moving amount from the terminal 82b and the terminal 82c may be performed in response to a request from the terminal 82a. The transmission of the information indicating the positioning accuracy and the moving amount from the terminal 82b and the terminal 82c may be performed by a unicast method. In the terminal 82a, the second acquisition unit 320 acquires the positioning accuracy transmitted from the terminal 82b and the terminal 82c, and the third acquisition unit 330 acquires the information indicating the moving amount transmitted from the terminal 82b and the terminal 82c.

In S706, in the terminal 82a, the first acquisition unit 310 acquires a relative distance to each of the terminal 82b and the terminal 82c. The first acquisition unit 310 may calculate the relative distance based on beacon signals from the terminal 82b and the terminal 82c, and may calculate the relative distance based on wireless signals for data communication including the wireless signals transmitted in S702 and S704.

In S710, the satellite signal reception unit 304 of the terminal 82a performs positioning based on a satellite signal received from a GNSS satellite, and outputs a current position of the terminal 82a.

In S711, the terminal 82a determines whether or not the terminal 82a is located indoors. Specifically, the setting unit 350 of the terminal 82a determines whether or not the terminal 82a is located indoors, based on the relative distance acquired by the first acquisition unit 310, the information indicating the positioning accuracy acquired by the second acquisition unit 320, and the information indicating the moving amount acquired by the third acquisition unit 330. Specifically, whether or not the terminal 82a is located indoors is determined by the method described with reference to FIGS. 4 to 6 or the like.

In S712, the communication control unit 370 of the terminal 82a determines whether or not to transmit position information. When the determination unit 340 determines that the terminal 82 is not located indoors, the communication control unit 370 determines to transmit the position information. On the other hand, when the determination unit 340 determines that the terminal 82a is located indoors, the communication control unit 370 determines not to transmit the position information. In this manner, the communication control unit 370 controls content of communication between the terminal 82 and an external server, based on a determination result of the determination unit 340. Specifically, the communication control unit 370 restricts transmission of the position information to the server 60 by the communication unit 390, based on the determination result of the determination unit 340. In the present execution sequence, a case where the communication control unit 370 determines to transmit the position information will be described.

In S713, the communication control unit 370 of the terminal 82a transmits, to the server 60, the position information indicating the current position of the terminal 82a measured by the satellite signal reception unit 304. The processing of S710 to S713 is periodically executed in the terminal 82a. Similarly, the communication control unit 370 of each of the terminal 82b and the terminal 82c periodically transmits, to the server 60, position information indicating a current position of each of the terminal 82b and the terminal 82c measured by the satellite signal reception unit 304. In the execution sequence of FIG. 7, for purpose of preventing the description from becoming complicated, the transmission of the position information from the terminal 82a, the terminal 82b, and the terminal 82c to the server 60 is collectively illustrated in S713. The execution sequence of FIG. 7 does not mean that transmission timings of the position information from respective terminals 82 to the server 60 are the same.

In S714, the assistance control unit 260 of the server 60 determines whether or not to provide traffic assistance to the vehicle 20 and the terminal 82, based on the position information of the terminal 82 acquired from the terminal 82 and the position information of the vehicle 20 acquired from the in-vehicle information processing apparatus 40.

For example, the assistance control unit 260 predicts a future position of the terminal 82, based on a history of the position information of the terminal 82, and predicts a future position of the vehicle 20, based on a history of the position information of the vehicle 20. When it is predicted based on the predicted future positions of the terminal 82 and the vehicle 20 that the future position of the vehicle 20 approaches the future position of the terminal 82 within a predetermined time of period, the assistance control unit 260 determines to provide traffic assistance. In the execution sequence of FIG. 7, it is assumed that it is determined to provide traffic assistance to the terminal 82a.

When it is determined that the traffic assistance to the terminal 82a is to be provided, in S716, the assistance control unit 260 controls the communication unit 290 through the communication control unit 270 to transmit, to the in-vehicle information processing apparatus 40, assistance information instructing to output an alert. Further, in S718, the assistance control unit 260 controls the communication unit 290 through the communication control unit 270 to transmit the assistance information instructing to output an alert to the terminal 82a determined as a target of traffic assistance. In this manner, the communication control unit 270 performs control for transmitting information indicating a traffic risk at a position where the terminal 82 is present, based on control of the assistance control unit 260.

When receiving the assistance information from the server 60, in S722, the in-vehicle information processing apparatus 40 notifies an occupant of the vehicle 20 by a human machine interface (HMI) function included in the in-vehicle information processing apparatus 40 in accordance with the assistance information. For example, the in-vehicle information processing apparatus 40 notifies the occupant that attention is to be paid to a pedestrian jumping out onto the road 90. The in-vehicle information processing apparatus 40 may notify the occupant of the vehicle 20 that attention is to be paid to the pedestrian jumping out onto the road 90 by voice and display on a display apparatus included in the vehicle 20.

When receiving the assistance information from the server 60, in S720, the terminal 82a notifies the person 80 that the vehicle 20 approaching the person 80 is present, by the HMI function included in the terminal 82a. The terminal 82a may notify the person 80 that a vehicle approaching the person 80 is present, by voice and/or vibration.

According to the execution sequence of FIG. 7, when it is determined that the terminal 82 is located indoors, the transmission of the position information can be suppressed. Therefore, the power consumption amount in the terminal 82 can be reduced. In addition, it is possible to suppress the server 60 from processing the position information of the terminal 82 located indoors, and thus it is possible to reduce an amount of computation required for the processing executed by the server 60. Further, when it is determined that the terminal 82 is located indoors, it is possible to suppress alert information from being output. Therefore, it is possible to suppress an alert from being output from the terminal 82 located indoors. Accordingly, it is possible to reduce annoyance caused by an unnecessary alert output from terminal 82.

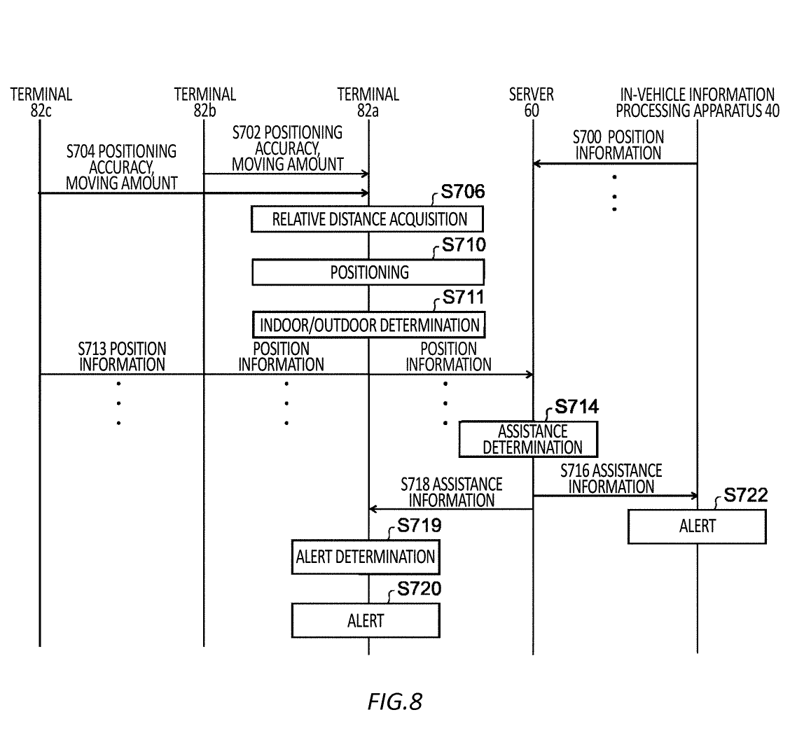

FIG. 8 illustrates another example of the execution sequence of the processing performed in the terminal 82, the in-vehicle information processing apparatus 40 of the vehicle 20, and the server 60. FIG. 8 particularly illustrates an execution sequence when the terminal 82a itself determines whether or not the terminal 82a is located indoors, based on positioning accuracy information from the terminal 82b and the terminal 82c, and determines whether or not the terminal 82a outputs an alert, based on the determination result. In the execution sequence of FIG. 8, it is assumed that the terminal 82b and the terminal 82c are determined to be located outdoors.

Regarding the processing of S700, S702, S704, S706, S710, S711, S713, S714, S716, S718, and S722 in FIGS. 7 and 8, processing denoted by the same reference numerals represents the same processing, and thus description of the processing will be omitted.

In S718, under the control of the assistance control unit 260, the assistance information instructing to output an alert is transmitted to the terminal 82a. When receiving the assistance information from the server 60, in S719, the terminal 82a determines whether or not to output an alert. Specifically, when it is determined as a result of a latest indoor/outdoor determination by the determination unit 340 that the terminal 82a is located indoors, the notification control unit 360 of the terminal 82a determines to output an alert. When it is determined as the result of the latest indoor/outdoor determination by the determination unit 340 that the terminal 82a is not located indoors, the notification control unit 360 determines not to output an alert. As described above, in the terminal 82a, the communication unit 390 receives the information indicating the traffic risk at the position where the terminal 82 is present, from the server 60 which distributes the information indicating the traffic risk, and the notification control unit 360 performs control for performing notification, based on the information indicating the traffic risk received by the communication unit 390. Specifically, the notification control unit 360 restricts the notification when the determination unit 340 determines that the terminal 82 is located indoors. In the present execution sequence, a case where the notification control unit 360 of the terminal 82a determines to output an alert will be described.

When the notification control unit 360 determines to output an alert in S719, the person 80 is notified that the vehicle 20 approaching the person 80 is present, by the HMI function included in the terminal 82 in S720. Since the processing of S720 of FIG. 8 is the same as the processing of S720 of FIG. 7, the description of the processing will be omitted.

According to the execution sequence of FIG. 8, when it is determined that the terminal 82 is located indoors, it is possible to suppress the alert information from being output. Therefore, it is possible to suppress an alert from being output from the terminal 82 located indoors. Accordingly, it is possible to reduce annoyance caused by an unnecessary alert output from terminal 82.

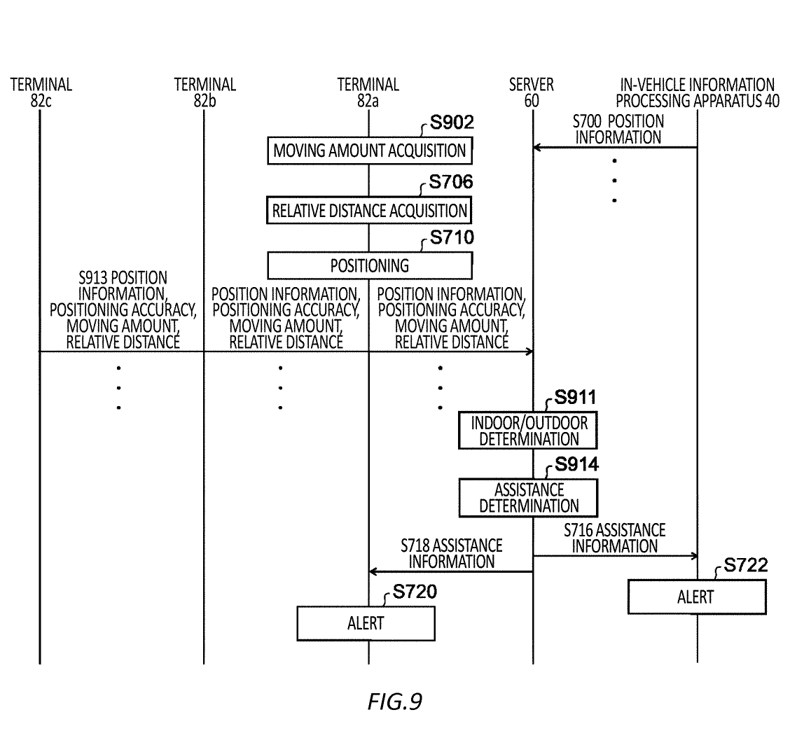

FIG. 9 illustrates another example of the execution sequence of the processing performed in the terminal 82, the in-vehicle information processing apparatus 40 of the vehicle 20, and the server 60. FIG. 9 particularly illustrates an execution sequence when the server 60 determines whether or not the terminal 82 is located indoors.

Regarding the processing of S700, S710, S716, S718, S720, and S722 in FIGS. 9 and 7, processing denoted by the same reference numerals represents the same processing, and thus description of the processing will be omitted.

In S902, the terminal 82a acquires a moving amount of the terminal 82a. For example, the terminal 82a acquires, as the moving amount, information indicating a step count per unit time counted by a step counter included in the terminal 82a.

In S913, the communication control unit 370 of the terminal 82a transmits, to the server 60, the position information indicating the current position of the terminal 82 measured by the satellite signal reception unit 304 in S710, the positioning accuracy output from the satellite signal reception unit 304 in S710, the moving amount of the terminal 82a acquired in the terminal 82a in S902, and the relative distance to another terminal 82 acquired in S706. The processing of S902, S706, S710, and S913 is periodically executed in the terminal 82a. Similarly, the communication control unit 370 of each of the terminal 82b and the terminal 82c transmits, to the server 60, the position information indicating the current position of each terminal 82, the positioning accuracy of each terminal 82, the moving amount of each terminal 82, and the relative distance between each terminal 82 and another terminal 82. In the execution sequence of FIG. 9, for the purpose of preventing the description from becoming complicated, the transmission of the position information from the terminal 82a, the terminal 82b, and the terminal 82c to the server 60 is collectively illustrated in S913. The execution sequence of FIG. 9 does not mean that transmission timings of the position information, the positioning accuracy, the moving amount, and the relative distance from respective terminals 82 to the server 60 are the same.

In S911, the server 60 determines whether or not each terminal 82 is located indoors. Specifically, the server 60 determines whether or not the terminal 82 is located indoors, by processing similar to the processing described with reference to FIG. 4. More specifically, in the server 60, the first acquisition unit 210 acquires the relative distance transmitted from each terminal 82, the second acquisition unit 220 acquires the positioning accuracy transmitted from each terminal 82, and the third acquisition unit 230 acquires the moving amount transmitted from each terminal 82. For each terminal 82, the determination unit 240 extracts positioning accuracy and a moving amount of another terminal 82 located within a predetermined distance, based on the relative distance, the positioning accuracy, and the moving amount, and calculates the index values L and H based on the extracted positioning accuracy and moving amount. The determination unit 240 compares the calculated index values L and H to determine whether or not each terminal 82 is located indoors.

In S914, the assistance control unit 260 of the server 60 determines whether or not to provide traffic assistance to the vehicle 20 and the terminal 82, based on the position information of the terminal 82 acquired from the terminal 82 and the position information of the vehicle 20 acquired from the in-vehicle information processing apparatus 40. At this time, the assistance control unit 260 excludes the terminal 82 determined to be located indoors by the determination unit 240, and for the terminal 82 determined not to be located indoors by the determination unit 240, determines whether or not to provide traffic assistance to the vehicle 20 and the terminal 82. Except for this point, the processing of the assistance control unit 260 in S914 is the same as the processing described in relation to S714 in FIG. 7.

As described with reference to FIG. 9, the assistance control unit 260 excludes the terminal 82 determined to be located indoors by the determination unit 240 and determines whether or not to provide traffic assistance, and the communication control unit 270 transmits the assistance information to the terminal 82 to which the assistance information is to be transmitted, based on the control of the assistance control unit 260. Accordingly, when the determination unit 240 determines that the terminal 82 is located indoors, the communication control unit 270 can restrict the transmission of the information indicating the traffic risk at the position where the terminal 82 is present, as compared with a case where the determination unit 240 determines that the terminal 82 is not located indoors. In this manner, the communication control unit 270 controls content of communication between the server and the terminal 82, based on the determination result of the determination unit 240.

According to the execution sequence of FIG. 9, it is possible to suppress the assistance determination of S914 from being performed for the terminal 82 located indoors, and thus, it is possible to reduce the amount of computation required for the processing executed by the server 60. In addition, in the terminal 82 determined to be located indoors, it is possible to suppress the alert information from being output, and thus, it is possible to reduce annoyance caused by an unnecessary alert output from terminal 82.

As described above, according to the assistance system 10, it is possible to determine whether or not the terminal 82 is located indoors, in consideration of the positional relationship with another surrounding terminal 82 and the positioning accuracy of the another surrounding terminal 82 and/or the determination result as to whether or not the another terminal 82 is located indoors. Therefore, even when it is not easy to determine whether or not the terminal 82 is located indoors, such as in a case where the terminal 82 is near the entrance of the building 92, whether or not the terminal 82 is located indoors can be determined with higher accuracy.

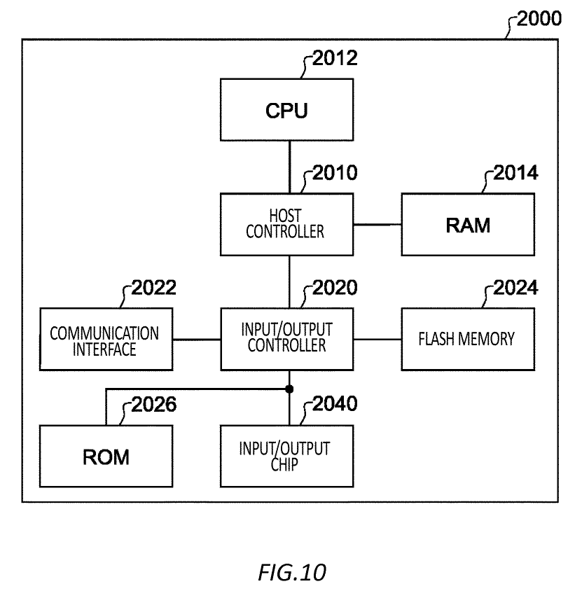

FIG. 10 illustrates an example of a computer 2000 in which a plurality of embodiments of the present invention may be entirely or partially embodied. A program installed in the computer 2000 can cause the computer 2000 to function as an apparatus such as the terminal 82 and the server 60, according to the embodiment, or each unit of the apparatus, execute an operation associated with the apparatus or each unit of the apparatus, and/or execute a process according to the embodiment or a stage of the process. Such a program may be executed by a CPU 2012 in order to cause the computer 2000 to execute a specific operation associated with some or all of the processing procedures and the blocks in the block diagrams described in the present specification.

The computer 2000 according to the present embodiment, includes the CPU 2012 and a RAM 2014, which are connected via a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 at the time of activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer readable storage medium such as a CD-ROM, a DVD-ROM, or a memory card. The RAM 2014, the ROM 2026, or the flash memory 2024 is an example of the computer readable storage medium. The program is installed in the flash memory 2024, the RAM 2014, or the ROM 2026, and executed by the CPU 2012. The information processing described in these programs is read into the computer 2000, resulting in cooperation between a program and the various types of hardware resources described above. An apparatus or method may be configured by achieving the operation or processing of information in accordance with the usage of the computer 2000.

For example, when a communication is executed between the computer 2000 and an external device, the CPU 2012 may execute a communication program loaded on the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 and the like to be read into the RAM 2014, and execute various types of processing on the data in the RAM 2014. Next, the CPU 2012 writes back the processed data into the recording medium.

Various types of information, such as various types of programs, data, a table, and a database, may be stored in the recording medium and may be subjected to information processing. The CPU 2012 may execute, on the data read from the RAM 2014, various types of processing, including various types of operations, information processing, conditional judgement, conditional branching, unconditional branching, information search/replacement, or the like described in the present specification and designated by instruction sequences of the programs, to write the results back to the RAM 2014. In addition, the CPU 2012 may retrieve information from a file, a database, or the like in the recording medium. For example, when a plurality of entries, each having an attribute value of a first attribute associated with an attribute value of a second attribute, are stored in the recording medium, the CPU 2012 may retrieve an entry having a designated attribute value of the first attribute that matches a condition from the plurality of entries, and read the attribute value of the second attribute stored in this entry, thereby acquiring the attribute value of the second attribute associated with the first attribute that satisfies a predetermined condition.

The program or software module described above may be stored in a computer readable storage medium on the computer 2000 or near the computer 2000. A recording medium such as a hard disk or a RAM provided in a server system connected to a dedicated communication network or the Internet can be used as the computer readable storage medium. A program stored in the computer readable storage medium may be provided to the computer 2000 via a network.

A program installed in the computer 2000 and causing the computer 2000 to function as the terminal 82 may work on the CPU 2012 or the like to cause the computer 2000 to function as each unit (for example, the determination apparatus 302 or the like) of the terminal 82. The information processing described in these programs is read into the computer 2000 to function as each unit of the terminal 82, which is a specific means in which software and the above-described various hardware resources cooperate. Then, with these specific means, by achieving computing or processing of information according to an intended use of the computer 2000 in the present embodiment, a unique terminal 82 is constructed according to the intended use.

A program installed in the computer 2000 and causing the computer 2000 to function as the server 60 may work on the CPU 2012 or the like to cause the computer 2000 to function as each unit (for example, the determination apparatus 202 or the like) of the server 60. The information processing described in these programs is read into the computer 2000 to function as each unit of the server 60, which is a specific means in which software and the above-described various hardware resources cooperate. Then, with these specific means, by achieving computing or processing of information according to an intended use of the computer 2000 in the present embodiment, a unique server 60 is constructed according to the intended use.

Various embodiments have been described with reference to the block diagrams and the like. In the block diagrams, each block may represent (1) a stage of a process in which an operation is executed, or (2) each unit of the apparatus having a role in executing the operation. A specific stage and each unit may be implemented by a dedicated circuit, a programmable circuit supplied with a computer readable instruction stored on a computer readable storage medium, and/or a processor supplied with a computer readable instruction stored on a computer readable storage medium. The dedicated circuit may include a digital and/or analog hardware circuit, or may include an integrated circuit (IC) and/or a discrete circuit. The programmable circuit may include a reconfigurable hardware circuit including memory elements such as logic AND, logic OR, logic XOR, logic NAND, logic NOR, and other logic operations, flip-flops, registers, field programmable gate arrays (FPGA), programmable logic arrays (PLA), and the like.

The computer readable storage medium may include any tangible device capable of storing an instruction executed by an appropriate device, so that the computer readable storage medium having the instruction stored thereon constitutes at least a part of a product including an instruction that may be executed in order to provide means for executing a processing procedure or an operation designated in a block diagram. Examples of the computer readable storage medium may include an electronic storage medium, a magnetic storage medium, an optical storage medium, an electromagnetic storage medium, a semiconductor storage medium, and the like. A more specific example of the computer readable storage medium may include a FLOPPY (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disk read-only memory (CD-ROM), a digital versatile disk (DVD), a BLU-RAY (registered trademark) disk, a memory stick, an integrated circuit card, or the like.

The computer readable instructions may include an assembler instruction, an instruction-set-architecture (ISA) instruction, a machine instruction, a machine-dependent instruction, a microcode, a firmware instruction, state-setting data, or either of source code or object code written in any combination of one or more programming languages including an object-oriented programming language such as SMALLTALK (registered trademark), JAVA (registered trademark), and C++, or the like, and a conventional procedural programming language such as a "C" programming language or a similar programming language.

The computer readable instruction may be provided for a processor or programmable circuit of a general-purpose computer, a special-purpose computer, or another programmable data processing apparatus, locally or via a local area network (LAN) or a wide area network (WAN) such as the Internet to execute the computer readable instruction in order to provide means for executing the explained processing procedure or the operation designated in the block diagram. Examples of the processor include a computer processor, a processing unit, a microprocessor, a digital signal processor, a controller, a microcontroller, and the like.

While the embodiments of the present invention have been described, the technical scope of the invention is not limited to the above-described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by "prior to," "before," or the like and as long as the output from a previous process is not used in a later process. Even if the process flow is described using phrases such as "first" or "next" in the claims, embodiments, or diagrams, it does not necessarily mean that the process must be performed in this order.

### EXPLANATION OF REFERENCES

10: assistance system; 20: vehicle; 40: in-vehicle information processing apparatus; 60: server; 82: terminal; 92: building; 80: person; 90: road; 200: processing unit; 202: determination apparatus; 210: first acquisition unit; 220: second acquisition unit; 230: third acquisition unit; 240: determination unit; 250: setting unit; 260: assistance control unit; 270: communication control unit; 280: storage unit; 290: communication unit; 300: processing unit; 302: determination apparatus; 304: satellite signal reception unit; 310: first acquisition unit; 320: second acquisition unit; 330: third acquisition unit; 340: determination unit; 350: setting unit; 360: notification control unit; 370: communication control unit; 380: storage unit; 390: communication unit; 2000: computer; 2010: host controller; 2012: CPU; 2014: RAM; 2020: input/output controller; 2022: communication interface; 2024: flash memory; 2026: ROM; and 2040: input/output chip.

What is claimed is:

1. A determination apparatus comprising:
a first acquisition unit which acquires first information indicating positional relationships between a terminal and one or more other terminals;
a second acquisition unit which acquires second information indicating at least one of a determination result, which is acquired in another terminal included in the other terminals, as to whether or not the another terminal is located indoors or positioning accuracy of the another terminal; and
a determination unit which determines whether or not the terminal is located indoors, based on the first information and the second information.

2. The determination apparatus according to claim 1, wherein
the first information includes information indicating a distance between the terminal and the another terminal.

3. The determination apparatus according to claim 2, wherein
the determination unit selects the another terminal having a distance to the terminal shorter than a predetermined value, based on the first information, and determines whether or not the terminal is located indoors, based on the second information of the another terminal selected.

4. The determination apparatus according to claim 1, further comprising
a third acquisition unit which acquires third information indicating a moving state of the another terminal, wherein
the determination unit determines whether or not the terminal is located indoors, based on the first information, the second information, and the third information.

5. The determination apparatus according to claim 4, wherein
the determination unit calculates an importance of the second information based on the third information, and determines whether or not the terminal is located indoors, by using the importance.

6. The determination apparatus according to claim 4, wherein
the third information indicates a moving amount per unit time of the another terminal.

7. The determination apparatus according to claim 4, wherein
the another terminal is a portable terminal, and
the third information indicates a step count counted in the another terminal.

8. The determination apparatus according to claim 4, wherein
the third acquisition unit acquires the third information based on a change amount of a distance between the terminal and the another terminal, which is acquired by short-distance wireless communication.

9. The determination apparatus according to claim 1, wherein
the second information indicates positioning accuracy of the another terminal, and
the positioning accuracy of the other terminal indicates at least one of reception sensitivity of a satellite signal received by the another terminal from a positioning satellite, a number of at least one satellite used for positioning for the another terminal, or an elevation angle of the satellite signal.

10. The determination apparatus according to claim 1, wherein
the determination unit determine whether or not the terminal is located indoors, by calculating an index value for determining whether or not the terminal is located indoors, based on the first information and the second information, and comparing the index value with a threshold, and
the determination apparatus further comprises
a setting unit which sets the threshold based on an instruction from a user of the terminal.

11. The determination apparatus according to claim 2, further comprising
a third acquisition unit which acquires third information indicating a moving state of the another terminal, wherein
the determination unit determines whether or not the terminal is located indoors, based on the first information, the second information, and the third information.

12. A terminal comprising:
the determination apparatus according to claim 1.

13. The terminal according to claim 12, further comprising
a communication control unit which controls content of communication between the terminal and an external server, based on a determination result of the determination unit.

14. The terminal according to claim 12, further comprising:
a communication unit which transmits position information of the terminal to a server which distributes information indicating a traffic risk at a position where the terminal is present; and
a communication control unit which restricts transmission of the position information to the server by the communication unit, based on a determination result of the determination unit.

15. The terminal according to claim 12, comprising:
a communication unit which receives information indicating a traffic risk at a position where the terminal is present, from a server which distributes information indicating a traffic risk; and
a notification control unit which performs control for performing notification, based on the information indicating the traffic risk received by the communication unit, wherein
the notification control unit restricts the notification when the determination unit determines that the terminal is located indoors.

16. A server comprising
the determination apparatus according to claim 1.

17. The server according to claim 16, further comprising
a communication control unit which controls content of communication between the server and the terminal, based on a determination result of the determination unit.

18. The server according to claim 16, further comprising
a communication control unit which performs control for transmitting information indicating a traffic risk at a position where the terminal is present, wherein
when the determination unit determines that the terminal is located indoors, the communication control unit restricts transmission of the information indicating the traffic risk at the position where the terminal is present, as compared with a case where the determination unit determines that the terminal is not located indoors.

19. A determination method comprising:
acquiring first information indicating positional relationships between a terminal and one or more other terminals;
acquiring second information indicating at least one of a determination result, which is acquired in another terminal included in the other terminals, as to whether or not the another terminal is located indoors or positioning accuracy of the another terminal; and
determining whether or not the terminal is located indoors, based on the first information and the second information.

20. A computer readable storage medium which is a non-transitory computer readable medium having stored thereon a program, the program causing, when executed by a computer, the computer to function as:
a first acquisition unit which acquires first information indicating positional relationships between a terminal and one or more other terminals;
a second acquisition unit which acquires second information indicating at least one of a determination result, which is acquired in another terminal included in the other terminals, as to whether or not the another terminal is located indoors or positioning accuracy of the another terminal; and
a determination unit which determines whether or not the terminal is located indoors, based on the first information and the second information.
